(19) United States
(12) Patent Application Publication
(10) Pub. No.: US 2002/0083309 A1
(43) Pub. Date: Jun. 27, 2002

(54) Hardware spill/fill engine for register windows

(75) Inventors: Daniel Leibholz, Newton, MA (US); Jason Eisenberg, Mountain View, CA (US)

Correspondence Address: LAHIVE & COCKFIELD, 28 STATE STREET, BOSTON, MA, 02109, US

(73) Assignee: SUN MICROSYSTEMS, INC.

(21) Appl. No.: 09/747,583

(22) Filed: Dec. 21, 2000

(51) Int. Cl. G06F 9/00

(52) U.S. Cl. 712/228; 712/41

(57) ABSTRACT

A spill/fill engine detects when a register window spill trap or a register window fill trap is imminent. The spill/fill engine takes steps to avoid the trap so as to not incur an undue amount of overhead in servicing the trap with a software trap handler. The spill/fill engine may be implemented in hardware. The traps may be avoided by injecting appropriate instructions into an instruction stream for execution.

### TECHNICAL FIELD

The present invention relates generally to microprocessors and more particularly to a hardware spill/fill engine for register windows.

### BACKGROUND OF THE INVENTION

Conventional microprocessors typically include general purpose registers. The general purpose registers may be logically partitioned into register windows. For example, each routine in a computer program may have separate associated register window representing a subset of the general purpose registers that may be accessed by instructions within the routine.

From a programming perspective, it is desirable to not put a fixed maximum on the number of register windows that are permitted. Otherwise, a limit of the depth of nesting of routines is imposed. This poses a complication in that there are a limited number of physical registers available on the microprocessor. Thus, conventional microprocessors provide mechanisms to virtually support an unlimited number of register windows. In particular, when a register window is to be added and all of the registers are currently used, a trap occurs. The trap is handled by a trap handler implemented in software. The trap handler shifts the contents of one of the register windows onto a storage to make room for the new register window. Such a situation is known as a “register window spill” that occurs in response to an overflow exception.

A trap also occurs when an underflow condition arises. An underflow condition occurs when the registers do not hold the contents for a given register window and the contents of the register window must be transferred from the storage to the registers. Such a situation is known as a “register window fill.” The trap is handled by a trap handler implemented in software.

The traps described above are particularly expensive. It takes a large amount of time for the trap handlers to be called and fully execute. With the ever increasing speed of microprocessors, such traps can significantly affect performance.

### SUMMARY OF THE INVENTION

The present invention addresses the above-described limitations of conventional microprocessors by implementing a spill/fill engine in hardware. The hardware spill/fill engine avoids the large overhead associated with traps that perform the register window spills and register window fills in conventional microprocessors. The hardware spill/fill engine detects an imminent register window fill or register window spill and generates appropriate instructions for avoiding the associated underflow or overflow condition. These instructions may be inserted directly into the instruction pipeline for execution with other instructions.

In accordance with one aspect of the present invention, a microprocessor includes registers for holding values. The registers are logically partitioned into register windows. The microprocessor also includes a storage for storing values held in the registers of the register windows. The detector is provided for detecting that either a register window overflow condition or a register window underflow condition is imminent. An instruction generator generates at least one instruction to avoid a trap responsive to the condition that is detected as imminent by the detector. The detector and the instruction generator may be implemented in hardware.

In accordance with another aspect of the present invention, an engine is found in a microprocessor having registers. The engine includes a detector and an instruction generator. The detector detects that a trap requiring access to the storage to manage register window information is imminent. The instruction generator is responsive to the detector for generating at least one instruction to avoid the trap.

### BRIEF DESCRIPTION OF THE DRAWINGS

An illustrative embodiment of the present invention will be described below relative to the following drawings.

FIG. 1 depicts an example of a register window.

FIG. 2 depicts how a current window pointer is used to differentiate between register windows.

FIG. 3 depicts an overlap between adjacent register windows.

FIG. 4 depicts general purpose registers and selected register window state registers used in the illustrative embodiment of the present invention.

FIG. 5 is a simplified block diagram of a microprocessor suitable for practicing the illustrative embodiment.

FIG. 6 is a flow chart illustrating the steps that are performed in the case of an imminent register window spill.

FIG. 7 depicts an example of the state of the registers immediately prior to the imminent register window spill.

FIG. 8 is a flow chart illustrating the steps that are performed to avoid the register window spill.

FIG. 9 depicts the state of the registers in an example case where a register window spill trap has been avoided.

FIG. 10 is a block diagram illustrating the spill/fill engine in more detail.

FIG. 11 illustrates a portion of the instruction generator for avoiding a register window spill.

FIG. 12 is a flow chart illustrating the steps that are performed to avoid a register window fill in the illustrative embodiment.

FIG. 13 illustrates an example of the state of the registers immediately prior to an imminent register window fill trap.

FIG. 14 is a flow chart illustrating the steps that are performed to avoid a register window fill trap in the illustrative embodiment.

FIG. 15 illustrates an example of the state of the registers after the register window fill trap has been avoided.

FIG. 16 illustrates a portion of the instruction generator for generating fill instructions in more detail.

### DETAILED DESCRIPTION OF THE INVENTION

The illustrative embodiment of the present invention provides a register window spill/fill engine for avoiding costly traps. In particular, the spill/fill engine of the illustrative embodiment detects when a register window spill or register window fill is imminent. As a result, costly traps are avoided. The spill/fill engine is implemented in hardware.

The spill/fill engine generates instructions that are inserted into an instruction stream to avoid a spill trap or a fill trap. The instructions may be retrieved from a memory, such as a read only memory (ROM) in response to selected conditions. The spill/fill engine examines instructions in an instruction cache that are slated for introduction into an execution pipeline. If instructions are found that will cause an overflow condition or underflow condition, the spill/fill engine generates instructions to avoid the overflow condition or the underflow condition.

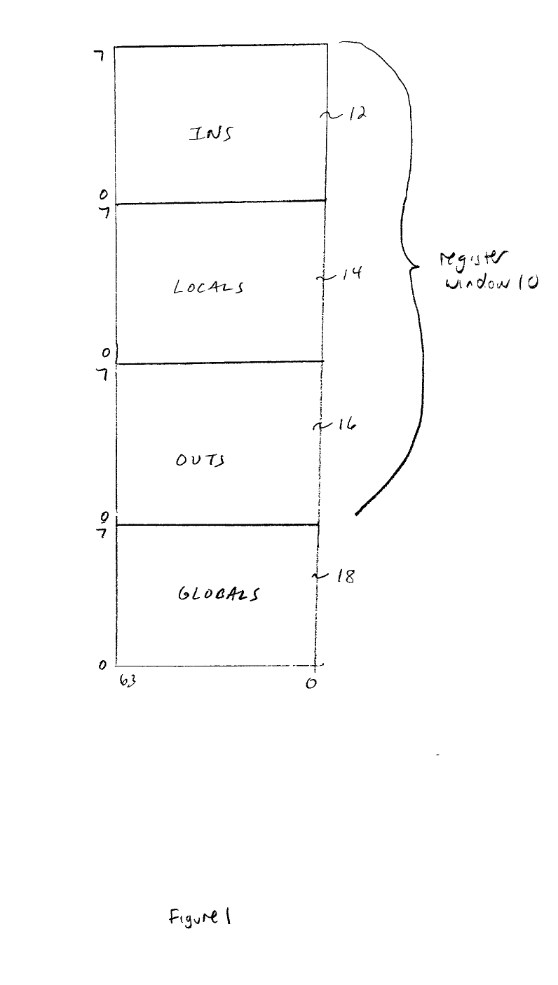

FIG. 1 depicts registers, including a register window 10 in the illustrative embodiment of the present invention. The register window includes three sets of registers 12, 14 and 16. Global registers 18 are also provided but are not part of the register window. Each of the sets of registers 12, 14, 16 and 18 includes eight registers. In FIG. 1, these registers are labeled from 0-7 in each of the sets 12, 14, 16 and 18. Each register window may be associated with and hold values for an associated routine.

The register window 10 includes input registers, labeled as “INS” in FIG. 1. The input registers 12 hold input values for an associated routine. These input values may be shared with an adjacent window, as will be described in more detail below. The register window 10 also includes local registers 14 holding values that are local to the routine associated with the register window. The output registers 16 hold values that may be shared with an adjacent registered window. Lastly, outside of the register window 10 are the global registers 18 that hold global values that are common to all routines.

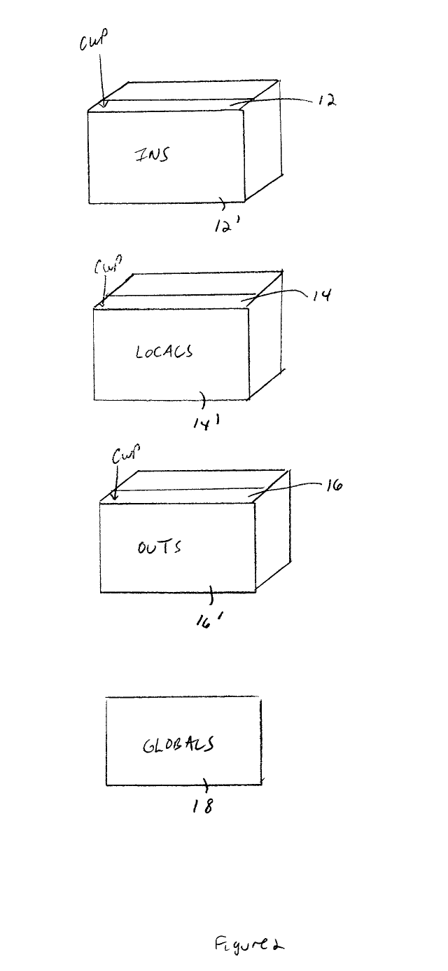

The above described registers are found in a microprocessor. The microprocessor of the illustrative embodiment maintains a current window pointer (CWP) that identifies a currently active register window. FIG. 2 shows a logical view of the register sets and illustrates how the CWP distinguishes amongst register windows. In the example shown in FIG. 2, the input registers 12 logically may be viewed as a three-dimensional block with the CWP identifying the current register window within the block. The CWP may be incremented or decremented to choose a different input register set in the block 12′. In similar fashion, the CWP identifies the local register set of the current register window in the block of local registers 14′ and the output register set of the current register window in a block of output registers 16′. Given that the global registers are shared, the global register set 18 is not represented as a three dimensional block but rather is a single register set.

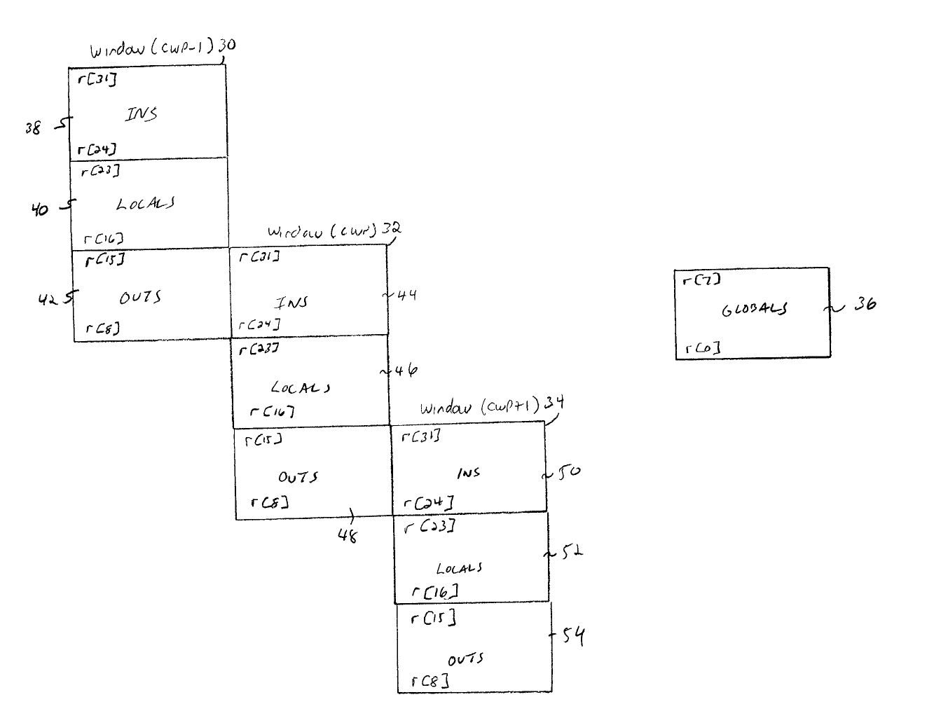

As was mentioned above, register windows may overlap. The register values held in the set of output registers for a first register window may also constitute the values held in the input registers of a second adjacent register window. FIG. 3 shows an example of three register windows and how they overlap. Registers r[0] through r[7] constitute the global register set 36. The three windows 30, 32 and 34 may be identified by the CWP−1, CWP and CWP+1, respectively. The register window 30 identified by the CWP−1 includes an output register set 42 including registers r[8] through r[15], a local register set 40 including registers r[16] through r[23], and an input register set 38 including registers r[24] through r[31].

Register window 32 overlaps with window 30 in that the values held in the output registers 42 become the values held in the input registers 44 of window 32. The window 32 also includes local registers 46 and output registers 48. Window 34 overlaps with window 32 as shown in FIG. 3. Window 34 includes input registers 50, local registers 52 and output registers 54.

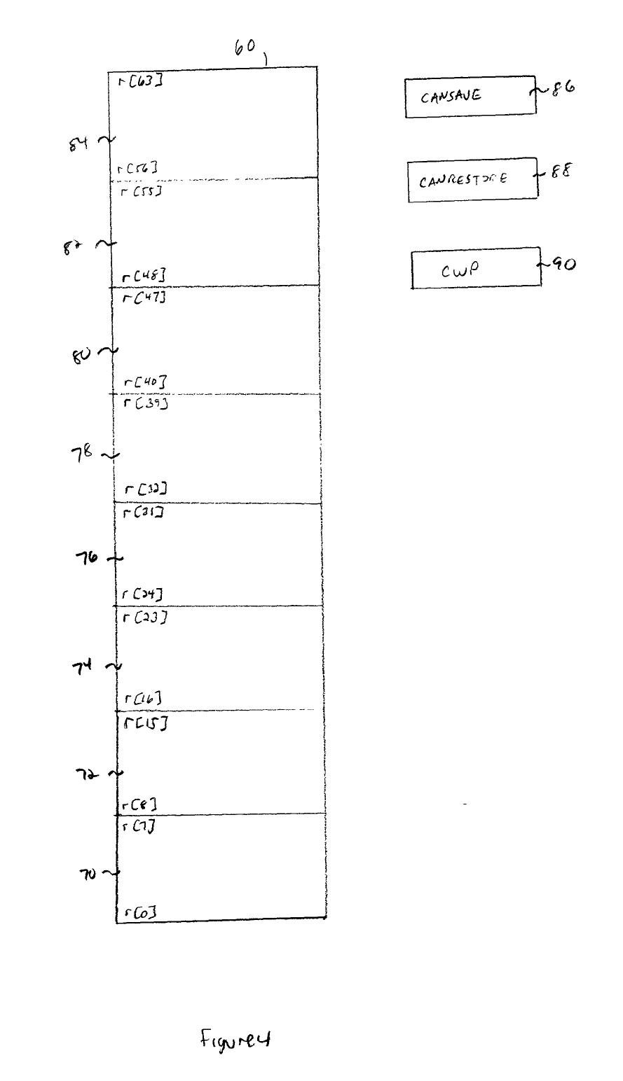

FIG. 4 shows an example of the general purpose registers found in the illustrative embodiment. These registers 60 include sixty-four registers indexed from r[0] to r[63]. The registers 60 may be partitioned in sets of eight registers 70, 72, 74, 76, 78, 80, 82 and 84. Those skilled in the art will appreciate that the present invention is not limited to instances wherein sixty-four registers are used. Moreover, those skilled in the art will appreciate that the present invention is not limited to instances where each of the register sets includes eight registers.

The registers also include register window state registers, such as the CANSAVE register 86. The CANSAVE register 86 holds a numerical value that identifies the number of register windows following the CWP that are not in use, and are, thus, available to be allocated without generating a register window spill. The CANRESTORE register 88 contains the number of register windows preceding the CWP that are in use by a current program and can be restored without generating a register window fill exception. The CWP 90 identifies the current register window.

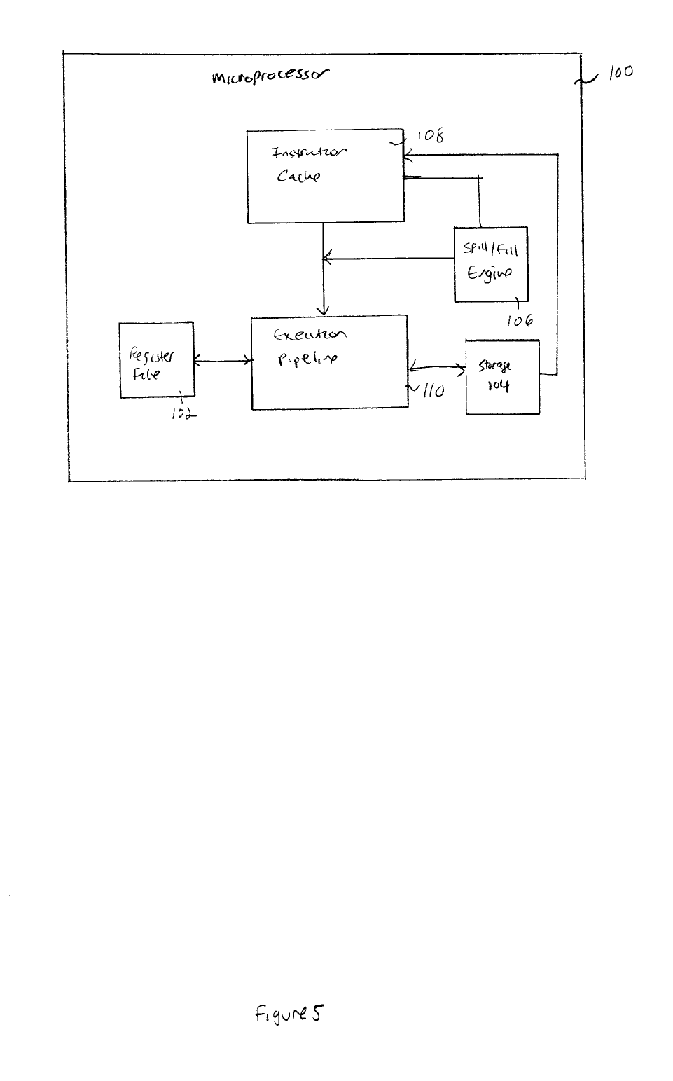

FIG. 5 shows a simplified block diagram of a microprocessor 100 that is suitable for practicing the illustrative embodiment of the present invention. For purposes of the discussion below, it is presumed that the microprocessor 100 is compatible with the SPARC, version 9 architectural standard established by the SPARC architecture committee of SPARC International. The microprocessor 100 includes a spill/fill engine 106 implemented in hardware. The microprocessor 100 also includes at least one register file 102 containing the registers of FIG. 4, such as depicted in FIG. 4. The microprocessor 100 includes a storage 104 for storing contextual information, as will be described in more detail below. The microprocessor 100 has an execution pipeline 110 that receives instructions from an instruction cache 108.

Those skilled in the art will appreciate that the present invention also may be practiced in microprocessor architectures that differ from that depicted in FIG. 5. The depiction in FIG. 5 is intended to be merely illustrative and not limiting of the present invention.

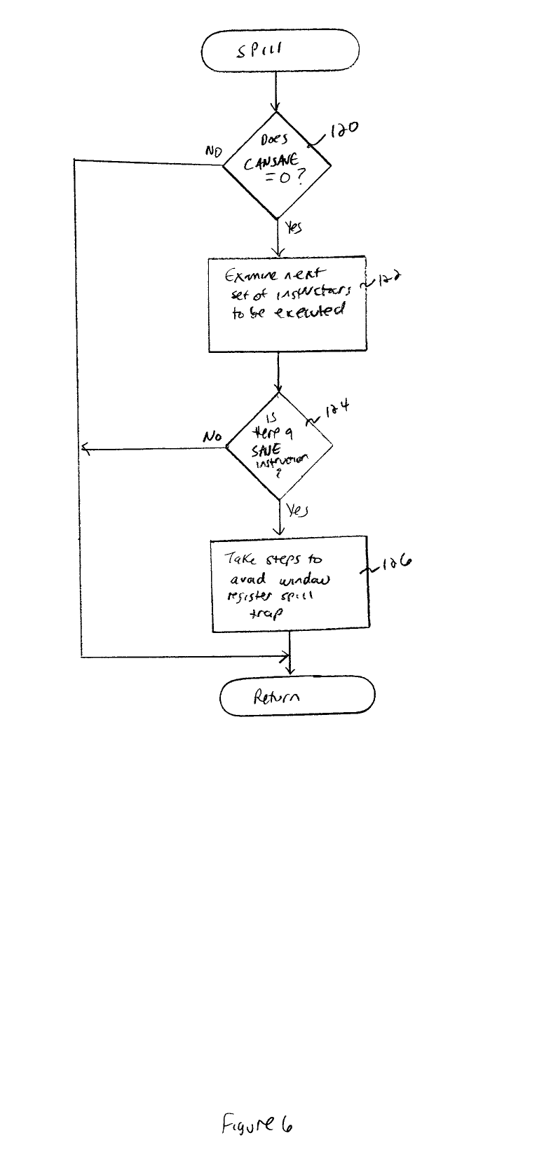

FIG. 6 is a flow chart illustrating the steps that are performed in the illustrative embodiment of the present invention to detect when a register window spill exception is imminent. Initially, the spill/fill engine 106 checks whether the CANSAVE register 86 has a value of 0 (step 120 in FIG. 6). As was mentioned above, the CANSAVE register 86 holds a value that identifies the number of register windows following the CWP that are not in use and are available for allocation. If the CANSAVE register 86 holds a value of 0, it is an indication that there are no more register windows that are available for allocation. The spill/fill register then examines the cached instructions in the instruction cache 108 that are next slated for insertion into the execution pipeline 110 (step 122 in FIG. 6). The instruction cache 108 holds sets of 8 instructions for insertion and parallel into the execution pipeline 110. These instructions represent the next instructions for which execution is to be initiated. The spill/fill engine 106 examines these instructions to determine if there is a SAVE instruction within them (step 124 in FIG. 6). A SAVE instruction provides a new register window for a routine. The new register window requires register space to be available among the registers 60. A SAVE instruction will result in a register window spill trap when the CANSAVE register 86 holds a value of 0. Such a trap would be handled by a software trap handler in a conventional microprocessor. To avoid the overhead of invoking the trap handler, the spill/fill engine 106 takes steps to avoid the window register spill trap (step 126 in FIG. 6). These steps will be described in more detail below.

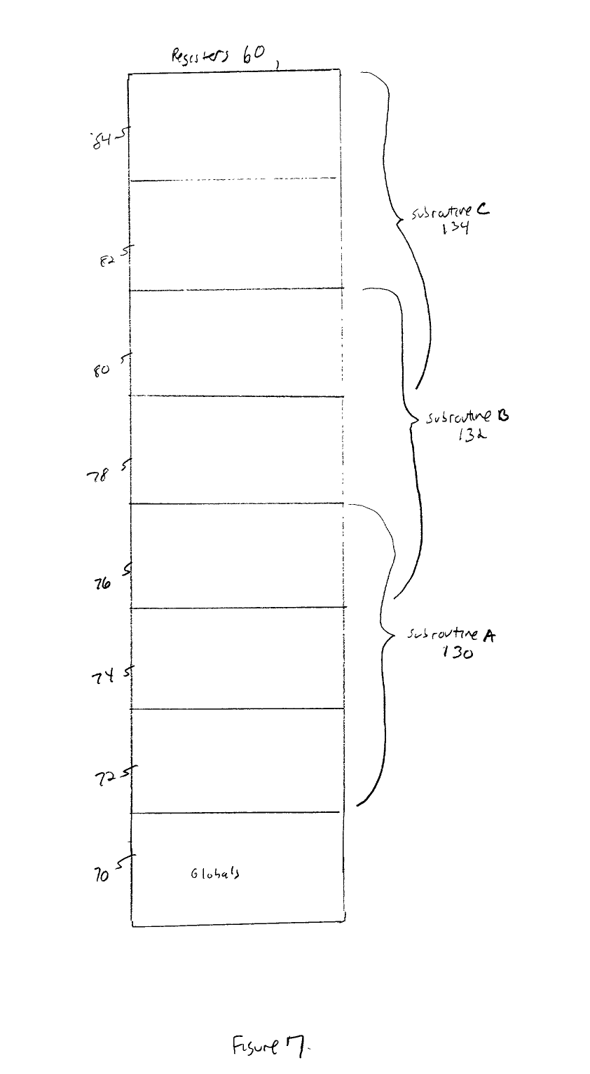

FIG. 7 shows an example wherein three subroutines A, B and C have been called in sequence. Register sets 72, 74 and 76 have been allocated for the register window for subroutine A 130. Register sets 76, 78 and 80 have been allocated for the register window for subroutine B 132. Lastly, register sets 80, 82 and 84 have been allocated for the register window for subroutine C 134. The storage 104 does not currently hold the contents of any register windows.

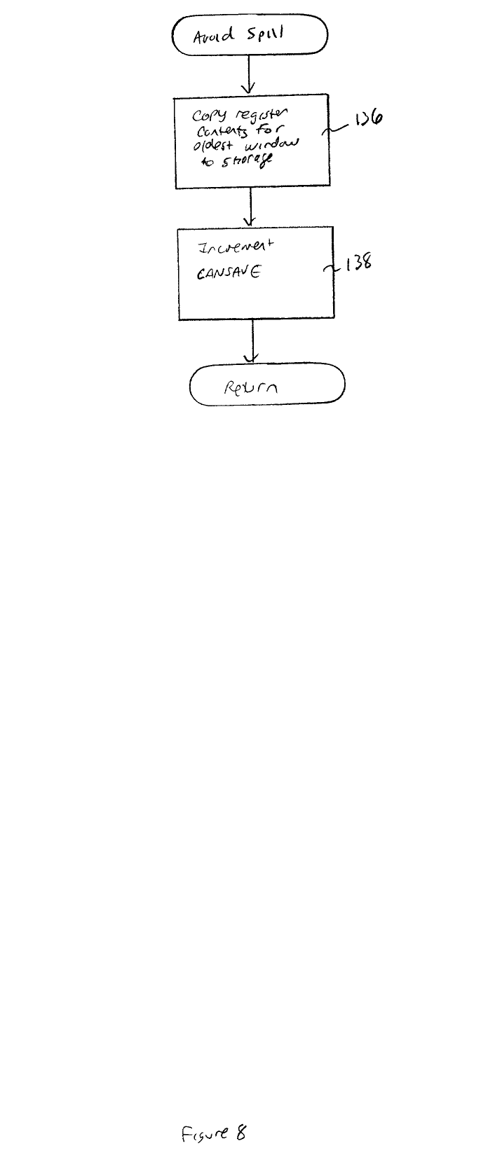

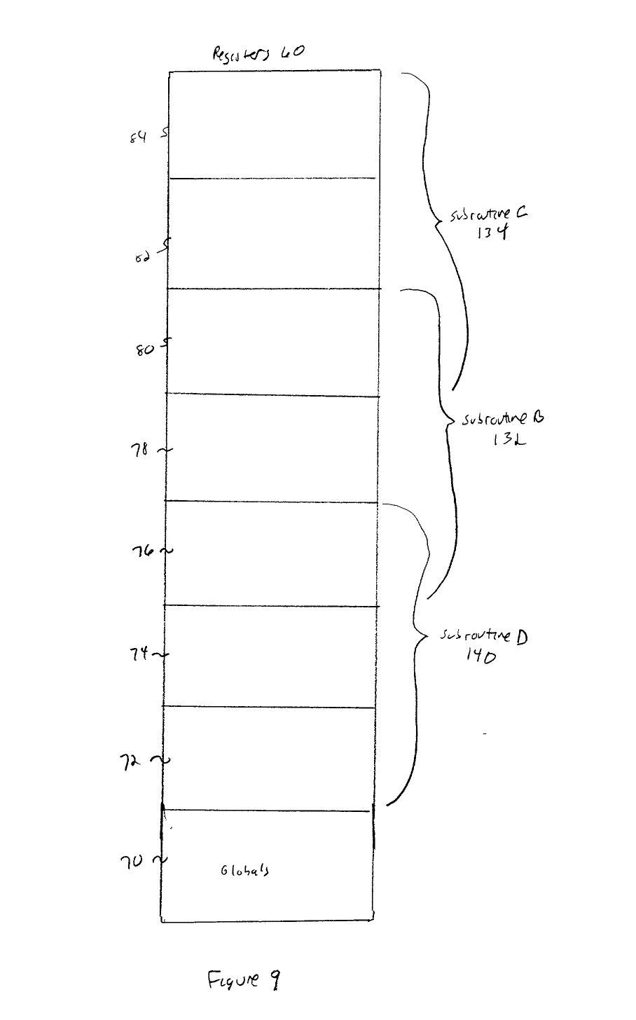

FIG. 8 depicts the steps that are performed in the illustrative embodiment by the spill/fill engine 106 to avoid the register window spill exception. In particular, the register contents for the oldest register window in the register 60 are copied from the register 60 to the storage 104 (step 136 in FIG. 8). The CANSAVE register 86 is then incremented to indicate that there is a register window available for allocation (step 138 in FIG. 8). FIG. 9 depicts the results for the example case of FIG. 7 when a fourth subroutine D is to be invoked and requires a register window. The contents of the register window for subroutine A 130 are stored in the storage 104, and the contents for the register window for subroutine D 140 are stored in the register 60.

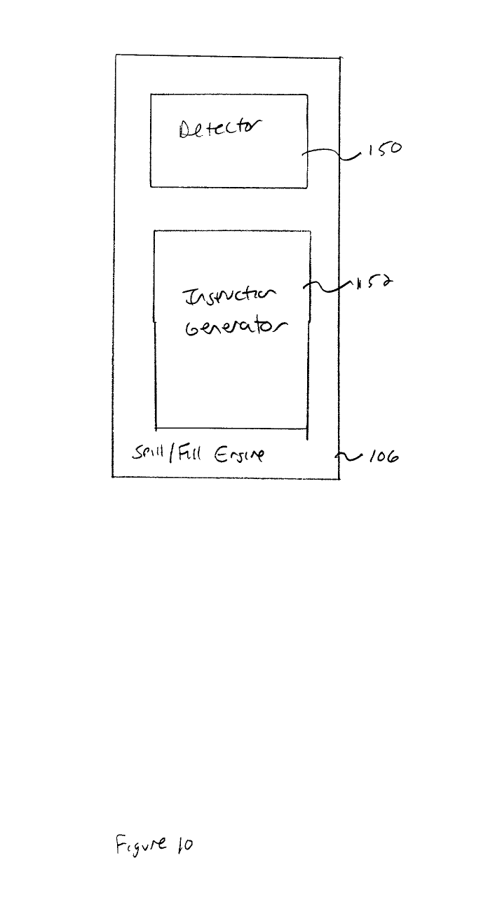

The above-described steps of FIG. 8 are performed by the spill/fill engine 106. As shown in FIG. 10, the spill/fill engine includes a detector 150 for detecting the SAVE instruction amongst the instructions contained in the instruction cache 108. The spill/fill engine 106 also includes an instruction generator 152 for generating the instructions for performing steps 136 and 138 in FIG. 8.

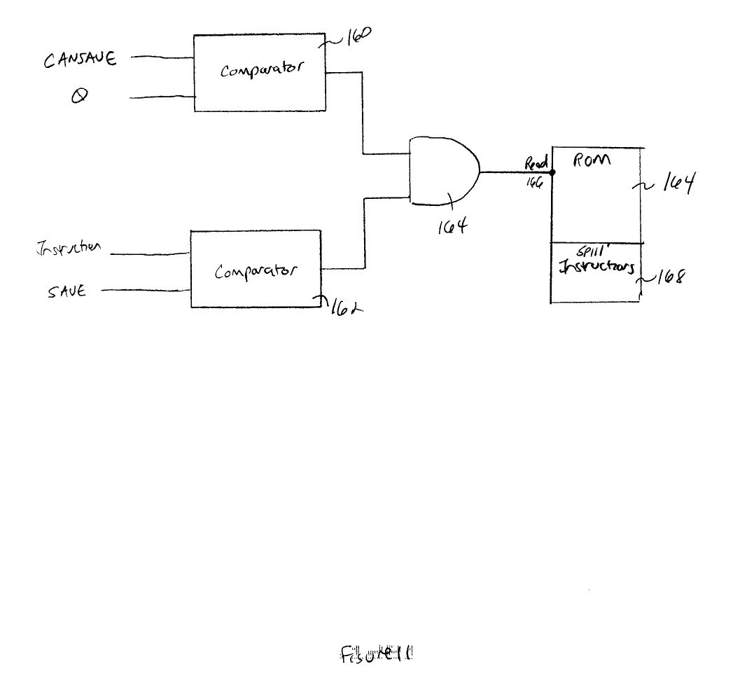

FIG. 11 shows in more detail a portion of the instruction generator 152 that is responsible for generating the instructions for avoiding the register window spill trap. As can be seen in FIG. 11, a comparator 160 compares a current value of the CANSAVE register 86 with the value of 0 to determine if the CANSAVE register currently has a value of 0. If the CANSAVE register value has a value of 0, the output of the comparator 160 is a logical 1 value; otherwise the output of the comparator 160 is a logical 0 value. A second comparator 162 compares the current instruction with the SAVE instruction to determine if the current instruction is a SAVE instruction. The output of the comparator 162 is a logical 1 value if the current instruction is a SAVE instruction; otherwise the output of the comparator 162 is a logical 0 value. The comparator 162 examines each of the instructions in the current set that is to be injected from the instruction cache 108 to the execution pipeline 110.

The outputs of the comparators 160 and 162 are fed into a logical AND gate 164. In the instance wherein the CANSAVE register 86 has value of 0 and the current instruction is a SAVE instruction, the output of the AND gate 164 is a logical 1 value that feeds into the read input line 166 of a read only memory (ROM) 164 to cause the spill instructions 168 stored therein to be output and inserted by the spill/fill engine 106 into the execution pipeline 110. The spill instructions 168 will be output only in the case where CANSAVE has a value of 0 and the current instruction is a SAVE instruction (indicating that a register window spill exception is imminent). The spill instructions 168 need not all be implemented in a single cycle to the execution pipeline 110, rather the microprocessor 100 includes a mechanism for applying backpressure so that there is room for the spill instructions 168 to be inserted into the execution pipeline before the SAVE instruction is executed. Hence, the spill instructions 168 may be executed over multiple cycles.

An example of suitable spill instructions are as follows:

1. H_SRL %sp, 0, %sp

2. H_STW %10, [%sp +BIAS32 +0]

3. H_STW %11, [%sp +BIAS32 +4]

4. H_STW %12, [%sp +BIAS32 +8]

5. H_STW %13, [%sp +BIAS32 +12]

6. H_STW %14, [%sp +BIAS32 +16]

7. H_STW %15, [%sp +BIAS32 +20]

8. H_STW %16, [%sp +BIAS32 +24]

9. H_STW %17, [%sp +BIAS32 +28]

10. H_STW %i0, [%sp +BIAS32 +32]

11. H_STW %i1, [%sp +BIAS32 +36]

12. H_STW %i2, [%sp +BIAS32 +40]

13. H_STW %i3, [%sp +BIAS32 +44]

14. H_STW %i4, [%sp +BIAS32 +48]

15. H_STW %i5, [%sp +BIAS32 +52]

16. H_STW %i6, [%sp +BIAS32 +56]

17. H_STW %i7, [%sp +BIAS32 +60]

18. H _SAVED

The SRL instruction shifts right logically by 32 bits and causes zeros to be set for the upper 32 bits of the registers. In the illustrative embodiment, it is presumed that the registers are 64 bits in length. The above instructions are for the case wherein only 32 bits of the registers are utilized. The STW instructions write values from respective registers to the addresses designated in the brackets. The instructions numbered 2-9 write register values from the local registers ranging from local register 0 (i.e., 10) to local register 7 (i.e., 17) to respective addresses in the storage. The instructions numbered 10 through 17 write the input registers into the storage. The global register values and the output register values must be maintained in the registers because they may be shared by other register windows. The SAVED instruction increments the CANSAVE register 86 by a value of 1.

Those skilled in the art will appreciate that the above-described instructions are intended to be nearly illustrative and not limiting of the present invention. Other types of instructions may be utilized to avoid the register window spill trap. Moreover, those skilled in the art will appreciate that the present invention may also be practiced in instances where the spill/fill engine does not generate instructions per se but rather uses alternative mechanisms for avoiding the register window spill trap. Still further, the logic contained in the instruction generator need not be implemented using components like that shown in FIG. 11. Those skilled in the art will appreciate that alternative implementations are available.

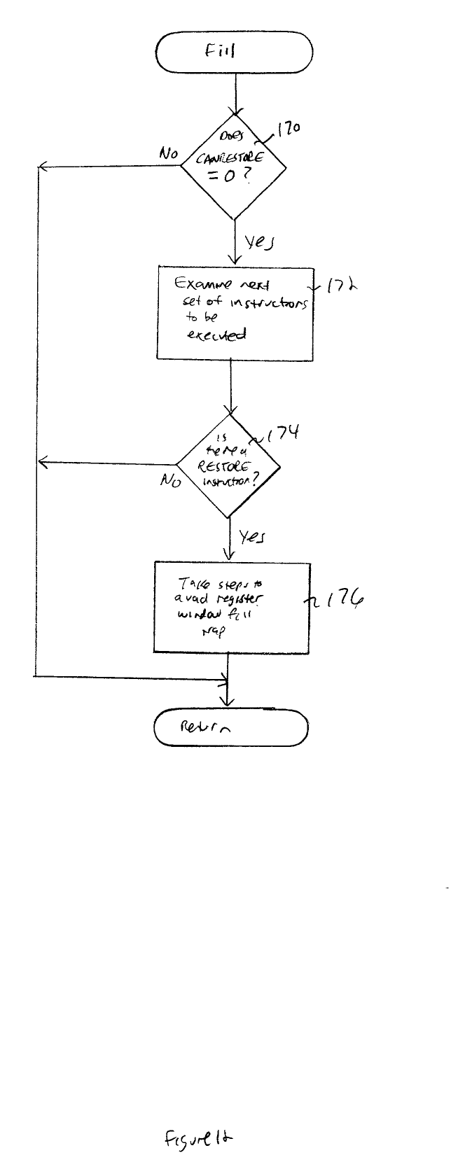

As mentioned above, the spill/fill engine 106 may also avoid traps for register window fills. FIG. 12 is flow chart illustrating the steps that are performed to avoid such register window fill traps. Initially, the spill/fill engine 106 checks whether the CANRESTORE register 88 has a value of 0 (step 170 in FIG. 12). If the CANRESTORE register has a value of 0 it indicates that there are no available register windows in the registers for restoration (i.e., to be pointed at by the CWP). The spill/fill engine then examines the next set of instructions in the instruction cache 108 that is slated for execution (step 172 in FIG. 12). The spill/fill engine 106 checks whether there is a RESTORE instruction in the examined set of instructions (step 174 in FIG. 12). If there is a RESTORE instruction, it is an indication that a register window fill exception is imminent because there are no register windows that could be restored. Hence, in such an instance, the spill/fill engine 106 takes steps to avoid the register window fill trap (step 176 in FIG. 12).

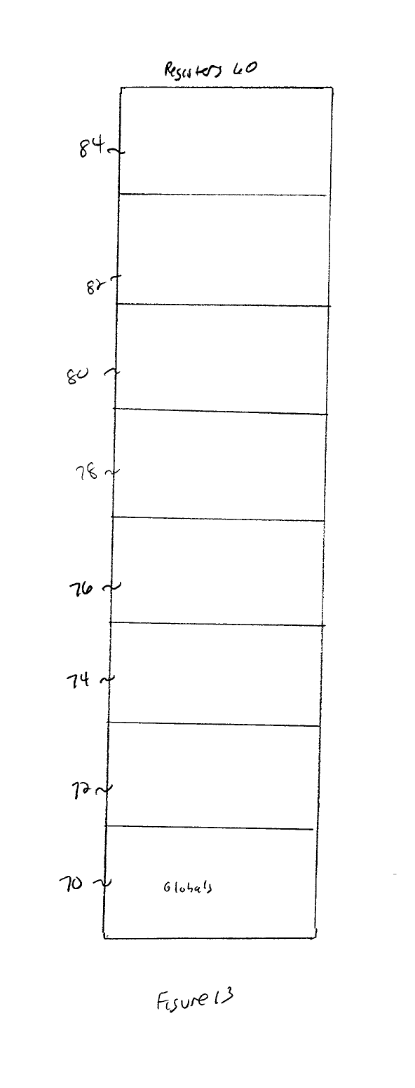

FIG. 13 shows an example wherein a register window fill exception is imminent. There are no values for register windows currently stored on the register 60. The subroutine A is about to begin execution and the contents of the register window for subroutine A 130 are stored in the storage 104.

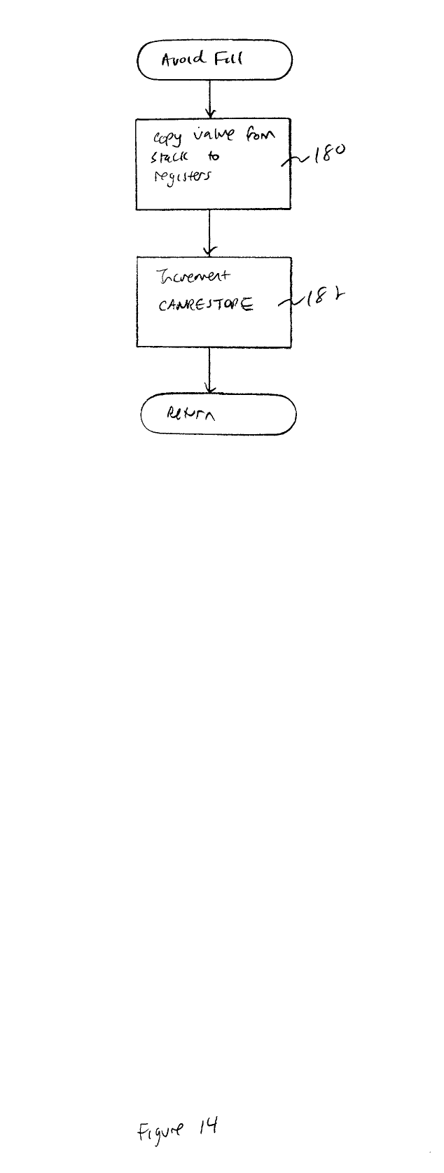

In order to avoid a register window fill exception, the illustrative embodiment copies the values from the register window that is to be restored from the storage 104 to the register 60 (step 180 in FIG. 14). Once this is completed, the CANRESTORE register 88 is incremented (182 in FIG. 14).

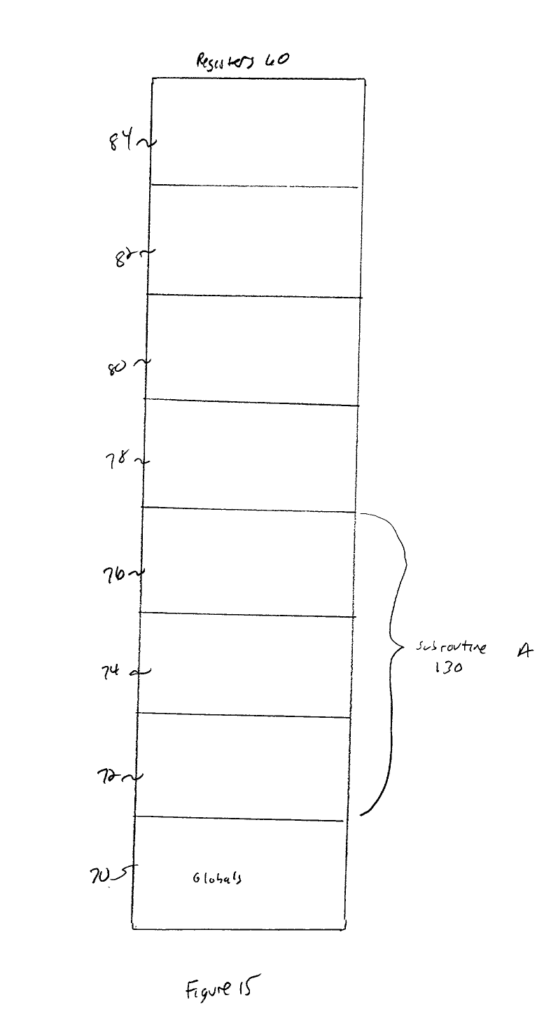

FIG. 15 shows the example of FIG. 13 when the steps of FIG. 14 have been performed to avoid the register window fill exception. The contents for the register window of subroutine A 130 have been transferred from the storage 104 to the register 60.

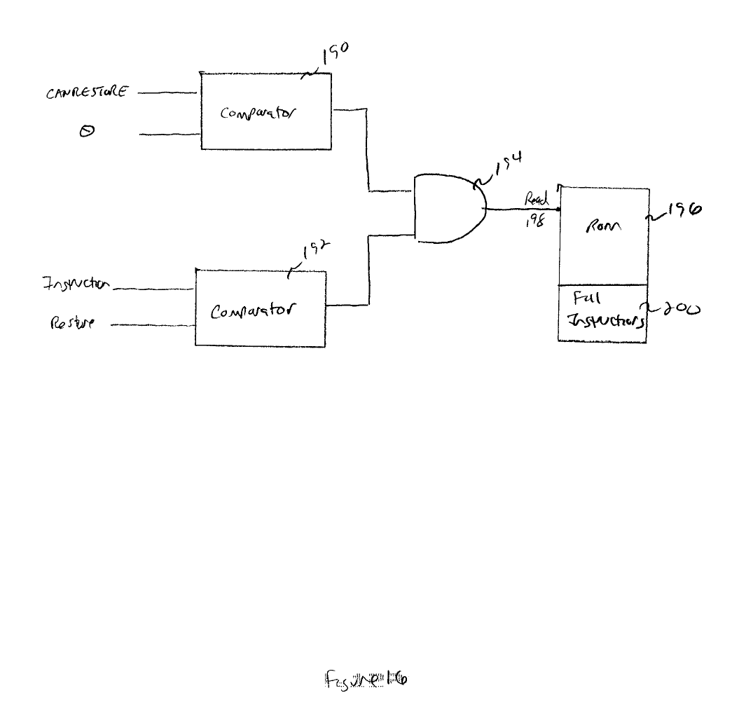

FIG. 16 depicts in more detail the portion of the instruction generator 152 that is provided to generate the fill instructions 200. A comparator 190 compares the value in the CANRESTORE register 88 with a value of 0. A comparator 192 compares a current instruction with the RESTORE instruction to determine if the current instruction is a RESTORE instruction. The outputs of the comparators 190 and 192 are fed into a logical AND gate 194. Where the CANRESTORE register 88 has a value of 0 and the current instruction is a RESTORE instruction, the read line 198 for the read only memory (ROM) 196 is activated so that the fill instructions 200 are inserted into the execution pipeline 110. As with the spill instructions 168, the fill instructions 200 may be inserted over multiple cycles by applying backpressure to the execution pipeline 110.

An example of suitable fill instructions is as follow:

1. H_SRL%sp,0,%sp

2. H_LDUW [%sp +BIAS32 +0], %10

3. H_LDUW [%sp +BIAS32 +4], %11

4. H_LDUW [%sp +BIAS32 +8], %12

5. H_LDUW [%sp +BIAS32 +12], %13

6. H_LDUW [%sp +BIAS32 +16], %14

7. H_LDUW [%sp +BIAS32 +20], %15

8. H_LDUW [%sp +BIAS32 +24], %16

9. H_LDUW [%sp +BIAS32 +28], %17

10. H_LDUW [%sp +BIAS32 +32], %i0

11. H_LDUW [%sp +BIAS32 +36], %i1

12. H_LDUW [%sp +BIAS32 +40], %i2

13. H_LDUW [%sp +BIAS32 +44], %i3

14. H_LDUW [%sp +BIAS32 +48], %i4

15. H_LDUW [%sp +BIAS32 +52], %i5

16. H_LDUW [%sp +BIAS32 +56], %i6

17. H_LDUW [%sp +BIAS32 +60], %i7

18. H_RESTORED

The LDUW instructions load values from an address specified by the first parameter into a register specified by the second parameter. The instructions shown above copy contents from the stack to the local registers and the input registers. The RESTORED instruction increments the CANRESTORE register value to indicate that there is a register window that can be restored as the current register window.

While the present invention has been described with reference to an illustrative embodiment thereof, those skilled in the art will appreciate that various changes in form and detail may be made without departing from the intended scope of the present invention as defined in the appended claims.

1. A microprocessor, comprising:
registers for holding values, wherein said registers are logically partitioned into register windows;
a storage for storing values held in the registers of the register windows;
a detector for detecting that one of a register window overflow condition and a register window underflow condition is imminent; and
an instruction generator responsive to the detector for generating at least one instruction to manipulate the storage to avoid a trap responsive to the condition that is detected as imminent.

2. The microprocessor of claim 1, wherein the detector and the instruction generator are implemented in hardware.

3. The microprocessor of claim 1, wherein the microprocessor further comprises a cache for caching instructions for introduction into an execution stage and wherein the detector examines the instructions in the cache to determine if a register window overflow condition is imminent by determining if execution of any of the fetched instructions will result in a register window overflow condition.

4. The microprocessor of claim 3, wherein the detector looks for an instruction in the cache that stores contents of a register window in the registers when the registers have no available space for storing the contents.

5. The microprocessor of claim 3, wherein the detector examines how much storage space is available in the registers.

6. The microprocessor of claim 1, wherein the microprocessor further comprises a cache for caching instructions for introduction into an execution stage and wherein the detector examines the instructions in the cache to determine if a register window underflow condition is imminent by determining if execution of the instructions will result in a register window underflow condition.

7. The microprocessor of claim 6, wherein the detector looks for an instruction in the cache that restores a register window when contents of the register window are stored on the stack rather than in the registers.

8. The microprocessor of claim 1, wherein the detector detects solely whether a register window underflow condition is imminent.

9. The microprocessor of claim 1, wherein the detector detects solely whether a register window overflow condition is imminent.

10. The microprocessor of claim 1, wherein the detector detects both whether a register window overflow condition is imminent and whether a register window underflow condition is imminent.

11. The microprocessor of claim 1, wherein the microprocessor further comprises an execution unit for executing the instruction generated by the instruction generator.

12. The microprocessor of claim 1, wherein the microprocessor performs out of order execution of instructions.

13. The microprocessor of claim 1, wherein the instruction generator includes a second storage for holding the at least one instruction that is generated by the instruction generator.

14. In a microprocessor having a storage and registers, an engine, comprising:
a detector for detecting that a trap requiring an access to the storage to manage register window information is imminent; and
an instruction generator responsive to the detector for generating at least one instruction to avoid the trap.

15. The engine of claim 14, wherein the engine is implemented in hardware.

16. In a microprocessor having a plurality of registers logically partitioned into register windows and a storage for storing contents of register windows, a method, comprising the steps of:
determining that one of a register window spill and a register window fill is imminent; and
in response to determining that the register window spill is imminent, manipulating the storage to avoid a trap responsive to the spill or the fill determined as imminent.

17. The method of claim 16, wherein, when it determined that a register window spill is imminent, the step of manipulating the storage comprises providing at least one instruction for execution by the microprocessor that causes the contents in at least the selected register window to be stored in the storage.

18. The method of claim 16, wherein, when it is determined that a register window fill is imminent, the step of manipulating the storage comprises providing at least one instruction for execution by the microprocessor that causes data in the storage to be stored in the registers.

19. The method of claim 16, wherein the microprocessor has an instruction stream slated for execution and wherein the instruction that causes the contents in at least the selected register window to be stored in the storage is inserted into the instruction stream.
